(19) United States
(12) Patent Application Publication
(10) Pub. No.: US 2010/0008322 A1
(43) Pub. Date: Jan. 14, 2010

(54) Data Transmission Device and Method for Data Transmission between a Network and a Mobile Data Transmission Unit

(75) Inventors: Armin Bossler, Wendlingen (DE); Steffen Pfendtner, Kernen i. R. (DE); Thomas Speidel, Markgroningen (DE)

Correspondence Address: GUDRUN E. HUCKETT DRAUDT, SCHUBERTSTR. 15A, WUPPERTAL, 42289, DE

(73) Assignee: ADS-TEC GMBH, Leinfelden-Echterdingen (DE)

(21) Appl. No.: 12/172,278

(22) Filed: Jul. 14, 2008

(51) Int. Cl. H04Q 7/00

(52) U.S. Cl. 370/331

(57) ABSTRACT

A data transmission device has a network, a mobile data transmission unit, and a driver. The network has at least two access points for establishing a wireless connection to the data transmission unit. The data transmission unit has an application generating user data, wherein the application is connected by an interface to the driver. The data transmission unit has at least two modules for transmitting data, wherein the at least two modules are connected to the driver. The data transmission unit has a switching device for switching between the at least two modules. The switching device operates such that in any switching state of the switching device user data generated by the application are transmitted by only one of the at least two modules.

### BACKGROUND OF THE INVENTION

The invention relates to a data transmission device comprising a network and a mobile data transmission unit, wherein the network has at least two access points for wireless connection to the data transmission unit and wherein the data transmission unit has an application for generating user data and wherein the application is connected by an interface to a driver. The invention further relates to a method for data transmission between a network and a mobile data transmission unit wherein the network has at least two access points for wireless connection to the data transmission unit and wherein the data transmission unit has an application for generating user data and wherein the application is connected by an interface to the driver.

U.S. 2007/0218888 A1 discloses a data communication device comprising several local area networks and a mobile data communication unit.

When a data communication unit moves away from a range of the first access point into the range of a second access point, in known data transmission units first the connection to the first access point is interrupted and subsequently a connection is established with the second access point that is closer. There is no connection to the network during the time period when the connection to the second access point is being established. During this time span user data that are to be transmitted must be cached. In particular in case of industrial applications the required time for establishing a connection to the second access point during which time no connection to the local area network is present and the resulting delay in data traffic are unacceptable. In known systems memory stacks are employed that are used intensively during the switching process. This caching of data leads to significant delays in data traffic.

WO 02/073430 A2 discloses a device and a method with which by means of a single device data can be transmitted by Bluetooth connection as well as a connection according to IEEE 802.11 standard. In order to prevent that the two connections will affect one another or disturb one another, it is proposed to switch between the connections so that only one of the connections is allowed at a time.

U.S. Pat. No. 7,046,649 B2 also discloses a device for transmission of data by Bluetooth connection as well as a connection according to IEEE 802.11 standard wherein switching between the two connections is also done for preventing disruptions.

### SUMMARY OF THE INVENTION

It is an object of the present invention to provide a data transmission (communication) device of the aforementioned kind with which an interruption of data transmission to the network is avoided. A further object of the present invention is to provide a method for data transmission between a network and a mobile data transmission unit with which an interruption of the data connection of the data transmission unit to the network is avoided.

With regard to the data transmission device this object is solved in that the data transmission (communication) unit has at least two modules for transmitting or communicating data which modules are connected to the driver and in that the data transmission unit has a switching device for switching between the modules. The switching device is configured such that in any switched state of the switching device user data, generated by the application, can be transmitted only by one of the modules, respectively.

Since the data transmission unit comprises two modules, one of the modules can be used to establish a new data connection while the other module is still being used for transmitting data. The switching device enables switching between the modules. Since user data can be transferred or communicated only through one of the modules, redundancy of transmitted data can be safely avoided. In local area networks it is therefore not required to provide additional devices for filtering user data that have been transmitted twice.

Advantageously, the switching device is connected to each module by means of a separate data connection and the switching device is configured such that in any switching state user data can be sent only through one of the data connections. The modules can thus be of conventional design. Switching between the modules is realized exclusively by means of the switching device. Advantageously, all of the modules in the network have a common MAC address (media access control address). For the network it is of no consequence through which one of the modules the user data are being transmitted or communicated. Since it is ensured that user data can be sent only through one of the modules, a common MAC address can be assigned to the modules. The network can therefore be of a conventional design. Special adaptations of the network in regard to the mobile data transmission units are not required. The number of required MAC addresses is therefore also not increased.

It can be provided that each module has an antenna for transmission of data. In this way, the modules can send at different frequencies. It can also be provided that at least two modules are connected by means of a splitter to a common antenna. In this way, the number of antenna can be reduced. In particular, only one antenna for all modules can be used. It can be provided that at least two modules send at different frequencies.

In a method for data transmission between a network and a mobile data transmission unit, wherein the network has at least two access points for wireless connection to the data transmission unit, it is provided that the data transmission unit has at least two modules for wireless transmission of data and a switching device for switching between the modules, wherein the switching device in a first switching state transmits user data only through a first module to a first access point and wherein the switching device, when one or several predetermined conditions are present, switches to a second switching state in which the switching device transmits user data only through a second module to a second access point.

By transmitting the user data only through the first module or only through the second module, it is possible to maintain a data connection to the network at all times. Switching can be realized free of any delay so that caching of the user data is not required.

Advantageously, at least one further module is searching for further access points and attempting to establish a standby data connection to a further access point while the first module is transmitting user data by a wireless data connection to the first access point. By having the further module already preparing a data connection to a further access point while user data are still being transmitted, the time that is required in known systems for logging in at a further access point, i.e., wasted time, can be eliminated. Advantageously, the switching device carries out the switching step from the first module to the second module after the second module has established a ready-to-operate standby data connection to the second access point. Establishing the standby data connection comprises advantageously authorization and registration at the network, processing of encryption and logging in at the network. It can also be provided that establishing the standby data connection comprises only some of these activities. Expediently, switching is done without delay and without caching of the user data. This configuration ensures that a data connection between the network and the mobile data transmission unit is present at all times. In this way, the use of the data transmission device is possible in particular in case of industrial applications in which a precisely timed transmission of data is important. It can be provided that at least two modules of the data transmission unit send at different frequencies. The network is in particular a local area network.

### BRIEF DESCRIPTION OF THE DRAWING

FIG. 1 is a schematic illustration of a first data transmission device according to the present invention.

FIG. 2 is a schematic illustration of a second data transmission device according to the present invention.

### DESCRIPTION OF THE PREFERRED EMBODIMENTS

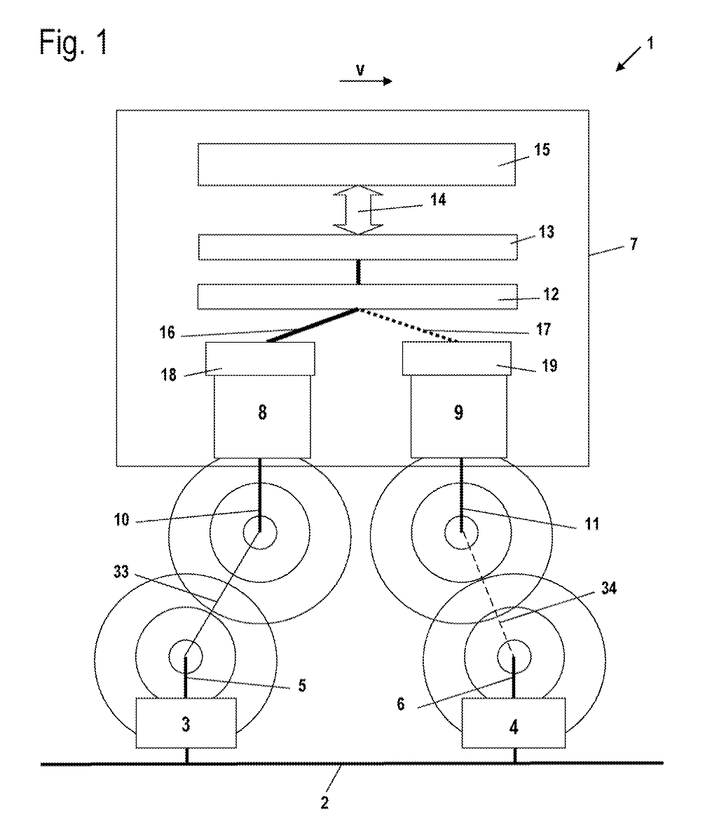

The data transmission device 1 schematically illustrated in FIG. 1 comprises a local area network that is, for example, an ethernet network. The local area network 2 has several, in particular a large number of access points. In FIG. 1 a first access point 3 and a second access point 4 are shown. The first access point 3 has an antenna 5 and the second access point 4 has an antenna 6, the antennas being used for wireless sending and receiving of data. The antennas 5 and 6 can send at the same frequency but it is also possible to employ different frequencies for antennas 5 and 6.

The data transmission device 1 comprises a mobile data transmission unit 7 that moves at velocity v relative to the local area network 2. The mobile data transmission unit 7 has an application 15 that generates user data. The user data generated by this application 15 can be of varying nature. For example, the application 15 can provide measured data. The application 15 is connected by an interface 14 to the driver 13. In particular, interface 14 is a programming interface (API=application programming interface). The driver 13 can be e.g. a WLAN (wireless local area network) driver, i.e., the driver typically used for operating a wireless local area network. The driver 13 is connected via switching device 12 to the first module 8 and the second module 9. The modules 8 and 9 are wireless modules. The module 8 has an antenna 10 and the module 9 has an antenna 11, the antennas being used for wireless transmission of data. The modules 8, 9 each have a memory stack 18, 19. The switching device 12 is connected by a first data connection 16 to the memory stack 18 of the first module 8 and by a second data connection 17 to the memory stack 19 of the second module 9. The data connection 16 serves for transmission of user data while the data connection 17 is in standby operation. The data connection 17 does not currently transmit user data but it is ready to perform user data transmission.

The memory stacks 18 and 19 serve for compensating protocol-specific delays encountered in wireless local area networks. For example, as a result of disruptions during user data transmission, it can become necessary that a data packet is requested again and must be resent. In this case, the subsequent user data can be cached in the memory stacks 18 and 19.

In FIG. 1, the switching device 12 is shown in a first switching state in which user data are transmitted by means of data connection 16 and first module 8. The first module 8 is connected by means of data connection 33 that is a wireless data connection to the first access point 3 of the local area network 2. By means of the data connection 33 the user data are transmitted from the first module 8 to the first access point 3. During transmission of the user data the second module 9 is searching for further access points. Once the second module 9 has found a second access point 4, it attempts to establish a standby data connection 34 to the second access point 4. Establishing the standby data connection 34 comprises authorization and registration of the second module at the second access point 4 of the local area network 2, the processing of encryption and logging in at the local area network. The standby data connection 34 is then ready for transmitting user data. Should the second module 9 be unable to establish a data connection to the second access point 4, for example, because the second access point 4 is overloaded (busy), the second module 9 continues to search for other access points for establishing a standby data connection. Even when a standby data connection to an access point has been successfully established, the second module 9 still continues to look for other access points to which a connection can be established that is better than the existing standby data connection.

The switching device 12 can switch between the modules 8 and 9 for example based on field strength that is generated by antennae 5 and 6 of the access points 3 and 4 at the mobile data transmission unit 7. For switching, further or additional conditions, for example, the WLAN frequency and/or time factors can be provided. The switching device 12 checks continuously whether the condition for switching has been filled. Once the condition for switching has been fulfilled and the second module 9 has established a standby data connection 34 to the second access point 4, the switching device 12 switches from first module 8 to the second module 9. The user data are no longer transmitted through the data connection 16 to the memory stack 18 of the first module 8 but, from the time of switching on, are transmitted to the memory stack 19 of the second module 9. Switching between the modules 8 and 9 is realized in a time frame of microseconds or milliseconds, particularly a few nanoseconds, i.e., without any measurable delay in regard to data transmission.

The switching device 12 checks the condition or the conditions for switching and controls the switching process. The switching device 12 comprises a microprocessor (CPU=central processing unit). The switching action is realized by software such that in the command code of the microprocessor two pointers are switched. The time required for the switching process depends on the processing speed of the employed microprocessor. At a processor speed of e.g. 533 MHz the switching process can be realized in approximately 20 ns. As a result of the short switching time caching of the data is not required. The memory stacks 18 and 19 are not needed for the switching process.

Since a data connection to the local area network 2 is present either through the first module 8 or through the second module 9, the user data can be transmitted without caching to the local area network 2. With the exception of the negligible short time period during which the switching device switches between the modules 8 and 9, a data connection is available at all times between the local area network 2 and the mobile data transmission unit 7. After switching, the first module 8 takes over the job of searching for further access points and attempts to establish a standby data connection to an access point. Every time switching take place, the functions of the first module 8 and of the second module 9 are switched.

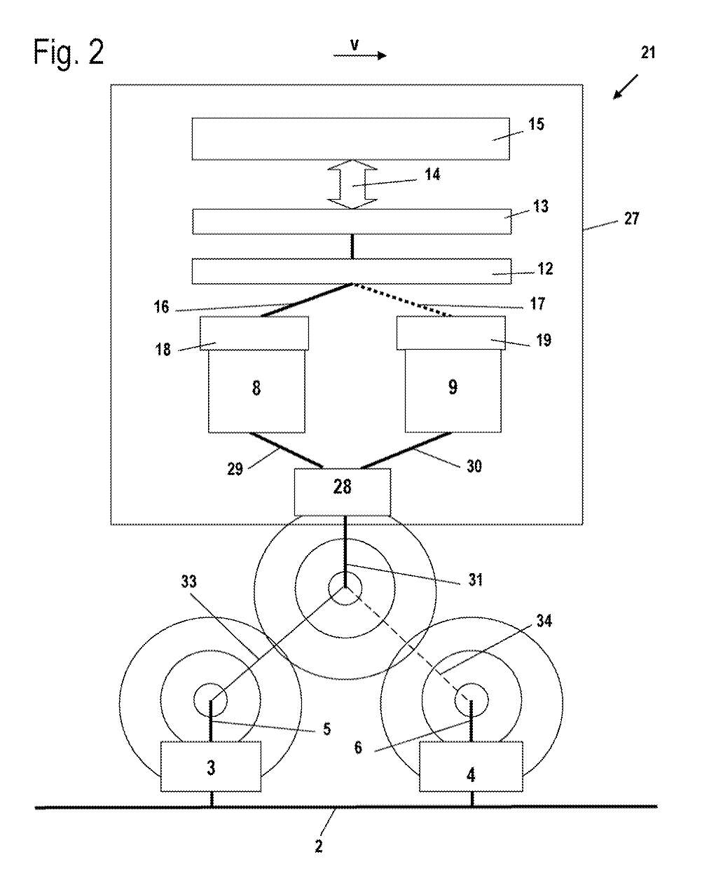

In FIG. 2 an embodiment of the data transmission device 21 is shown whose configuration corresponds substantially to that of the data transmission device 1. Same reference numerals identify same components. The data transmission device 21 has a mobile data transmission unit 27 with a first module 8 and a second module 9. The first module 8 is connected by data connection 29 to a splitter 28 and the second module 9 is connected by data connection 30 to the splitter 28. The splitter 28 has an antenna 31 by means of which the first module 8 generates a data connection 33 to the first access point 3 and by means of which the second module 9 at the same time establishes a standby data connection 34 to the second access point 4. Both modules 8, 9 thus utilize the same antenna 31. The splitter 28 separates the data transmitted to the modules 8 and 9 and compiles the data that are being transmitted by the modules 8 and 9.

It can be provided that the data transmission unit 7 or 27 has more than two modules. The modules transmit either at the same frequency or at different frequencies. All modules 8, 9 have in the local area network 2 the same MAC address (media access control address), i.e., the same hardware address.

While specific embodiments of the invention have been shown and described in detail to illustrate the inventive principles, it will be understood that the invention may be embodied otherwise without departing from such principles.

What is claimed is:

1. A data transmission device comprising:
a network;
a mobile data transmission unit;
a driver;
wherein the network has at least two access points for establishing a wireless connection to the data transmission unit;
wherein the data transmission unit has an application generating user data, wherein the application is connected by an interface to the driver;
wherein the data transmission unit has at least two modules for transmitting data, wherein the at least two modules are connected to the driver;
wherein the data transmission unit has a switching device for switching between the at least two modules;
wherein the switching device is configured such that in any switching state of the switching device user data generated by the application are transmitted by only one of the at least two modules.

2. The data transmission device according to claim 1, wherein the switching device is connected by a separate data connection to each one of the at least tow modules and wherein the switching device is configured such that in any switching state user data are sent through only one of the data connections.

3. The data transmission device according to claim 1, wherein the at least two modules have a common MAC address in the network.

4. The data transmission device according to claim 1, wherein the at least two modules each have an antenna for transmitting data.

5. The data transmission device according to claim 1, further comprising a splitter and a common antenna, wherein the at least two modules are connected by the splitter to the common antenna.

6. The data transmission device according to claim 1, wherein the at least two modules transmit at different frequencies.

7. The method for data transmission between a network and a mobile data transmission unit, wherein the network has at least two access points for wireless connection to the data transmission unit, wherein the data transmission unit has an application for generating user data, and wherein the application is connected by an interface to a driver, the method comprising the steps of:
providing the data transmission unit with a switching device and at least two modules for wireless transmission of data, wherein the switching device is connected to the at least two modules;
connecting the at least two modules to the driver;
transmitting in a first switching state of the switching device user data generated by the application only from a first one of the at least two modules to a first access point;
switching, when one or several predetermined conditions are present, to a second switching state of the switching device and transmitting user data generated by the application only through a second one of the two modules to a second access point.

8. The method according to claim 7, further comprising the step of searching said second access point and attempting to establish a standby data connection to said second access point with said second one of the at least two modules while said first one of the at least modules transmits user data to said force access point.

9. The method according to claim 8, wherein the step of switching is carried out after said second one of the at least two modules has established a ready-to-operate standby data connection to said further access point.

10. The method according to claim 8, wherein establishing the standby data connection comprises authorization and registration at the network, processing of encryption and logging in at the network.

11. The method according to claim 7, wherein the step of switching is realized without delay and without caching of the user data.

12. The method according to claim 7, wherein the at least two modules transmit at different frequencies.
